(19) United States
(12) Patent Application Publication
(10) Pub. No.: US 2024/0084048 A1
(43) Pub. Date: Mar. 14, 2024

(54) COMPOSITION, PROCESS FOR THE PRODUCTION THEREOF, USE THEREOF AND PROCESS FOR THE COATING OF SURFACES

(71) Applicant: BERGOLIN GmbH & Co. KG, Osterholz-Scharmbeck (DE)

(72) Inventors: Martin KRULL, Bockhorn (DE); Matthias OTTING, Bremen (DE)

(73) Assignee: BERGOLIN GmbH & Co. KG, Osterholz-Scharmbeck (DE)

(21) Appl. No.: 18/310,911

(22) Filed: May 2, 2023

(30) Foreign Application Priority Data
Sep. 13, 2022 (DE) 102022123339.1

(51) Int. Cl. C08F 2/50; C08F 220/18; C08F 222/10; C08K 3/36; C09D 4/00; C09D 7/63; C09D 7/80

(52) U.S. Cl. CPC C08F 2/50; C08F 220/1811; C08F 220/1812; C08F 222/102; C08F 222/1065; C08K 3/36; C09D 4/00; C09D 7/63; C09D 7/80

(57) ABSTRACT

A UV-light-curable composition based on at least one urethane acrylate oligomer, to a process for producing the composition, to a use of the composition and to a process for the coating of surfaces with the aid of the composition. The UV-light-curable composition of the invention has the characteristic feature of easy and quick handling. It hardens very rapidly and can undergo further working, for example sanding, immediately after curing, and can immediately after curing be coated with a further layer. In addition, the curing of the composition of the invention can be monitored easily and without outlay on equipment; the monitoring of the curing process is very reliable. Lastly, the composition of the invention has the characteristic feature of extremely good adhesion to the surface coated therewith and also to further layers that have been applied thereon.

### CROSS REFERENCE TO RELATED APPLICATIONS

This patent application claims priority on and the benefit of German Patent Application No. 10 2022 123 339.1 having a filing date of 13 Sep. 2022.

### BACKGROUND OF THE INVENTION

### Technical Field

The present invention relates to a UV-light-curable composition based on at least one urethane acrylate oligomer, to a process for producing the composition, to a use of the composition, and to a process for the coating of surfaces with the aid of the composition.

### Prior Art

The coatings and adhesives industry uses polymer-based coating compounds and paints for the coating of surfaces. The coatings are employed for example for decorative purposes, to give the surfaces special properties, such as a certain feel or elasticity, or to protect the surfaces from external influences such as weathering, aggressive chemicals, or other stresses.

Such coating compounds comprise either high-molecular-weight polymers or lower-molecular-weight oligomers. The latter polymerize on the surface into polymeric networks, thereby forming a stable coating. High-molecular-weight polymers on the other hand form the coating by drying on the surface, as a result of which the stability of the layer is lower. The drying process takes several days.

The polymerization employs free-radical or ionic polymerization mechanisms that can be initiated by higher temperature or by exposure to light. Standard commercial coating masses based on lower-molecular-weight oligomers need at least 30 minutes to some hours until polymerization/curing is complete. If two or more layers of such coating compounds are to be applied to the surface on top of one another, this is in itself already labour-intensive. Moreover, after each individual layer has been applied, the layer needs to first cure and then be machined, for example sanded, to achieve better adhesion of the subsequent layer. This results in disadvantageously long standing times or wait times for the workpiece with the surface that is to be coated.

A further disadvantage is that these standard commercial coating compounds generally consist of what are known as 2-component systems. In these systems it is necessary for two different reactants to come into contact with one another before the polymerization can commence. To prevent the polymerization from commencing prematurely, the two reactants are stored separately from one another, in each case as one component of the coating compound. The two components are not combined and mixed until shortly before application to a surface, so that the polymerization starts after application to the surface. However, any unused portion of the mixed coating compound then hardens and is no longer usable for further layers. This portion must be disposed of. A disadvantage of 2-component coating compounds is therefore that the coating process takes more time, since an additional work step is necessary for combining and mixing the components. The need to dispose of unused portions of the coating compound also gives rise to economic and ecological disadvantages.

In the case of coating compounds for which polymerization is initiated through exposure to light, this is done for example with ultraviolet (UV) light. UV light is light in the wavelength range from about 100 nm to about 400 nm. The source employed for the UV light is for example a mercury-vapour lamp. The use of radiation-curable coating compounds is often perceived critically, since it is difficult to see where on the surface the applied coating compound has already been fully cured by the UV light source and where it has not. This is also particularly problematic for workpieces having large surfaces to be coated, such as in the automobile construction, wind turbine, or yacht construction sectors. A further disadvantage is that it is not possible to fully cure a layer of coating compound of any desired thickness, since UV light is unable to penetrate the full thickness/depth of the layer in the case of high layer thicknesses. This leads, depending on the depth of the layer, to uneven curing and consequently to an irregular structure and therefore overall to a coating having lower stability. Therefore, an individual layer of a coating compound for which polymerization is initiated by exposure to light is generally applied to a surface in a thickness of 80 μm to 120 μm and maximally up to a thickness of about 1 mm.

There is therefore still a need for novel UV-curable coating compounds, the curing of which can be easily and reliably monitored. The coating compounds should cure evenly and curing should be both rapid and possible through a high layer thickness. In addition, they should be easy to handle, permit significantly shorter standing times and processing times, and avoid the economic and ecological drawbacks mentioned. It is also desirable that the coating compound, once cured, adheres well to the coated surface and that the coating compound also has good adhesion to further layers applied thereon.

### BRIEF SUMMARY OF THE INVENTION

This object is achieved according to the invention by A UV-light-curable composition comprising at least one difunctional urethane acrylate oligomer, preferably aliphatic, diluted with a reactive diluent, preferably an acrylate monomer; a thiol-functionalized acrylate oligomer; at least one type I photoinitiator activatable with UV light; and at least one colour-change indicator that upon irradiation with UV light changes from coloured to colourless. Thus, the invention relates in a first aspect to a UV-light-curable composition. In a second aspect the invention relates to a process for producing said composition. The invention relates in a third aspect to a use of the composition as a troweling compound. In a fourth aspect the invention relates to a process for coating a surface with the composition. Lastly, in a fifth aspect the invention relates to a product coated with the composition.

### DETAILED DESCRIPTION OF PREFERRED EMBODIMENTS

To achieve the object described above, the present invention proposes—according to the first aspect of the invention—a UV-light-curable composition comprising the following constituents:
1) at least one difunctional urethane acrylate oligomer, preferably aliphatic, diluted with a reactive diluent, preferably an acrylate monomer;
2) a thiol-functionalized acrylate oligomer;
3) at least one type I photoinitiator activatable with UV light; and
4) at least one colour-change indicator that upon irradiation with UV light changes from coloured to colourless.

The processes, uses, and products of the invention can encompass the same features that are elucidated in more detail herein for the composition. Further features, uses, products, and the composition are defined elsewhere herein.

The UV-light-curable composition of the invention has the characteristic feature of easy and quick handling. It hardens very rapidly and can undergo further working, for example sanding, immediately after curing. It can also immediately after curing be coated with a further layer, for example a layer of the composition of the invention, or a layer of a different coating compound or of a paint. It thus also permits a multilayer structure without intermediate sanding of intermediate layers. This avoids long standing times and wait times. The UV-light-curable composition of the invention is a one-component system, unused portions can be reused. The composition of the invention also has a pot life of unlimited length and can be stored for long periods and worked with over a long time. In addition, the curing of the composition of the invention can be monitored easily and without outlay on equipment, since this is possible visually, for example with the human eye. The monitoring is moreover very reliable. The UV-light-curable composition of the invention can in an individual coating cycle be applied to a surface and cured in a high layer thickness of up to 5 mm. All these advantageous characteristics of the UV-light-curable composition of the invention result in processing times being massively shortened. Lastly, the composition of the invention has the characteristic feature of extremely good adhesion to the surface coated therewith and also to layers that have been applied to a layer of the composition of the invention.

The composition of the invention is a radiation-cured composition. In the case of radiation-cured compositions it is possible to produce from certain compounds, for example multiply unsaturated compounds, through exposure to high-energy radiation, highly crosslinked polymers that can be used inter alia as coatings for surfaces. For the polymerization/curing, it is possible to use two different processes, UV curing and electron-beam curing. In the case of UV curing, a radiation-cured composition is irradiated with certain UV emitters. The radiation-cured composition of the invention is a composition curable with UV light (ultraviolet light). The high-energy radiation of UV light results in the generation, from UV initiators (photoinitiators) likewise present in the composition, of free radicals that in turn initiate a free-radical chain polymerization in the unsaturated components of the composition, thereby leading to crosslinking. With the use of certain initiators it is also possible for a polymerization to be conducted as a cationic polymerization.

Serving as what are known as binders in the UV-light-curable composition of the invention are binders having acrylate functions, specifically polyurethane acrylates. The reaction of polyurethane compounds containing terminal isocyanate groups with hydroxyalkyl acrylates (monoesters of acrylic acid with a diol) affords polyurethane acrylates having terminally unsaturated groups. These polyurethane acrylates are reacted under the influence of UV light with monomers in the form of what are known as reactive diluents, resulting in the formation of a polymeric network. In the UV-light-curable composition of the invention, at least one urethane acrylate oligomer is employed as the urethane acrylate component. The at least one urethane acrylate oligomer is difunctional. Preferably, the at least one urethane acrylate oligomer is aliphatic.

The at least one urethane acrylate oligomer is present in the composition of the invention diluted with or dissolved in a reactive diluent. The reactive diluent is preferably an acrylate monomer.

In a preferred embodiment of the composition, the at least one difunctional urethane acrylate oligomer according to constituent 1 comprises at least two difunctional urethane acrylate oligomers selected from:
1a) a difunctional urethane acrylate oligomer, preferably aliphatic, diluted with a difunctional acrylate monomer, preferably dipropylene glycol diacrylate (DPGDA); and
1b) a difunctional urethane acrylate oligomer, preferably aliphatic, diluted with a monofunctional acrylate monomer, preferably isobornyl acrylate (IBOA),
   wherein the urethane acrylate oligomers according to constituents 1a and 1b are preferably different from one another.

The difunctional urethane acrylate oligomer according to constituent 1a of the composition is selected preferably from Miramer DP 408 or Photocryl DP408NT (products of Miwon Specialty Chemical Co., Ltd.). The difunctional urethane acrylate oligomer according to constituent 1a is present in the composition of the invention diluted with or dissolved in a reactive diluent, a difunctional acrylate monomer. More preferably, the difunctional urethane acrylate oligomer according to constituent 1a has a content in the reactive diluent solution of 50% by weight to 70% by weight, particularly preferably 60% by weight.

The reactive diluent according to constituent 1a is selected preferably from dipropylene glycol diacrylate (DPGDA), hexane-1,6-diol diacrylate (HDDA) and tripropylene glycol diacrylate (TPGDA). The solution of the difunctional urethane acrylate oligomer in the reactive diluent according to constituent 1a is under standard conditions liquid and at 25° C. has a viscosity of 26 Pa-s. The content of the reactive diluent added to the content of the difunctional urethane acrylate oligomer comes to a total of 100% by weight for constituent 1a.

The difunctional urethane acrylate oligomer according to constituent 1 b of the composition is selected preferably from Miramer UA5216 (product of Miwon Specialty Chemical Co., Ltd.). The difunctional urethane acrylate oligomer according to constituent 1b is present in the composition of the invention diluted with or dissolved in a reactive diluent, a monofunctional acrylate monomer. More preferably, the difunctional urethane acrylate oligomer according to constituent 1 b has a content in the reactive diluent solution of 30% by weight to 50% by weight, particularly preferably 40% by weight. The difunctional urethane acrylate oligomer according to constituent 1b preferably has a molecular weight of 10,000 g/mol to 50,000 g/mol, more preferably of 20,000 g/mol to 40,000 g/mol, particularly preferably of 30,000 g/mol, the molecular weight having been determined by gel-permeation chromatography (GPC).

The reactive diluent according to constituent 1 b is selected preferably from isobornyl acrylate (IBOA), 3,3,5-trimethylcyclohexyl acrylate (TMCHA) and 4-tert-butylcyclohexyl acrylate (TBCHA). The solution of the difunctional urethane acrylate oligomer in the reactive diluent according to constituent 1 b is under standard conditions liquid and at 25° C. has a viscosity of 20,000 cps. The content of the reactive diluent added to the content of the difunctional urethane acrylate oligomer comes to a total of 100% by weight for constituent 1 b.

The UV-light-curable composition of the invention comprises as constituent 2 a thiol-functionalized acrylate oligomer. The thiol-functionalized acrylate oligomer according to constituent 2 is selected preferably from Miramer ES4420NT (product of Miwon Specialty Chemical Co., Ltd.). Preferably, the thiol-functionalized acrylate oligomer is under standard conditions liquid and at 25° C. has a viscosity of 1000-3000 cps. The thiol-functionalized acrylate oligomer according to constituent 2 preferably has a molecular weight of 500 g/mo to 2000 g/mol, more preferably of 1000 g/mol to 1500 g/mol, particularly preferably of 1250 g/mol, the molecular weight having been determined by gel-permeation chromatography (GPC). The presence in the UV-light-curable composition of the invention of the thiol-functionalized acrylate oligomer according to constituent 2 has the effect that the composition cures rapidly and evenly upon irradiation with UV light, even in the case of higher layer thicknesses.

The UV-light-curable composition of the invention comprises as constituent 3 at least one type I photoinitiator activatable with UV light. Photoinitiators are chemical compounds that after absorption of (UV) light in a photolysis reaction break down with the formation of reactive species capable of commencing (initiating) a reaction, for example a polymerization. The reactive species are free radicals or cations. UV light in the range from 250 nm to 400 nm is normally used for this purpose.

Photoinitiators for the free-radical chain reaction are subdivided into two types. Type I photoinitiators generate free radicals directly in a photofragmentation. The free radical formed then initiates the chain polymerization. Type II photoinitiators by contrast abstract a hydrogen atom from a neighbouring molecule, thereby forming a free radical. Cationic photoinitiators upon breakdown generate a Brønsted or Lewis acid.

Preferably, the at least one type I photoinitiator according to constituent 3 of the UV-light-curable composition of the invention is selected from the group comprising α-hydroxyaryl ketone, acyl phosphine oxide, acyl phosphinate, and a mixture thereof; more preferably 2-hydroxy-2-methyl-1-phenylpropanone (Omnirad 1173), ethyl (2,4,6-trimethylbenzoyl)phenylphosphinate (Lucirin TPO-L, absorption maximum at 369 nm, product of BASF Aktiengesellschaft, Ludwigshafen, Germany), phenylbis(2,4,6-trimethylbenzoyl)phosphine oxide (Keycure PI-981, absorption maxima at 338, 378, 405 nm), 2,4,6-trimethylbenzoyldiphenylphosphine oxide (Lucirin TPO, product of BASF Aktiengesellschaft, Ludwigshafen, Germany), and a mixture thereof. The composition of the invention preferably contains no thermoinitiator and no initiators containing peroxide or azo groups.

The UV-light-curable composition of the invention comprises as constituent 4 at least one colour-change indicator that upon irradiation with UV light changes from coloured to colourless. The at least one colour-change indicator according to constituent 4 is selected preferably from the group comprising CR234-BT2B, CR234, CR234B1, CR234BT1, CR236, CR234-R33, and CR234-V4 (products of Spectra Photopolymers, USA); more preferably CR234-BT2B and CR236. The colour-change indicators CR234-BT2B, CR234, CR234B1, CR234BT1 are blue before exposure to UV light, the colour-change indicators CR236 and CR234-R33 are red before exposure to UV light and the colour-change indicator CR234-V4 is purple before exposure to UV light. All colour-change indicators become colourless through exposure to UV light. The loss of colour of the colour-change indicators upon exposure to UV light is total and irreversible.

The colour-change indicators ensure that the UV-light-curable composition of the invention before exposure to UV light and before curing/polymerization is the colour of the colour-change indicator, i.e., coloured. Upon exposure to UV light, the colour of the UV-light-curable composition fades. Once the composition has cured, the colour is completely discharged. The colour-change indicator thus indicates when the UV-light-curable composition has cured. This is advantageous because, when coating a surface with the UV-light-curable composition, it is possible to work in a time-efficient manner. The irradiation of a coated surface/curing need be carried out only for as long as it takes for curing to be achieved. It is not necessary to expend additional time on curing to make sure that curing has occurred. The ability to visualize curing with the aid of a colour-change indicator is additionally advantageous for the coating process when the available UV light sources are not capable of irradiating the entire coated surface at the same time. The UV light source must therefore be moved over the surface (or conversely, the surface must be passed under the UV light source) until every part of the surface has received sufficient irradiation to achieve curing of the applied UV-light-curable composition. In this situation it is very helpful, through the colour of the composition, to be able to see which area of the surface has already cured and to target the UV light source at the areas that have not yet cured. The ability to visualize curing with the aid of the colour-change indicator is likewise advantageous in the subsequent outcome check, since the colour of the composition makes it easy to identify any area of the coated surface that inadvertently has not been cured or not been cured sufficiently. Further curing can then be targeted there, thereby optimizing the quality of the coating. This makes it possible, advantageously, to completely coat both small surfaces in the range up to 4 m², preferably 10 cm² to 4 m². Completely coat in this case means without imperfections. It can be a completely new coating that is applied or it can be a repair of a damaged area in an existing coating. What is particularly advantageous is that it is possible to completely coat large surfaces too, as are present in the automobile construction and wind turbine sectors, for example in rotor blades, or in yacht construction.

In a further embodiment of the UV-light-curable composition, the composition comprises as a further constituent:
5) an acrylic ester, preferably a dodecyl acrylate ester, more preferably a monofunctional lauryl acrylate monomer. Even more preferably, constituent 5 is selected from Miramer M122 (product of Miwon Specialty Chemical Co., Ltd.). Preferably, the acrylic ester is under standard conditions liquid and at 25° C. has a maximum viscosity of 15 cps. The presence in the UV-light-curable composition of the invention of the acrylic ester according to constituent 5 helps to optimally adjust the viscosity of the composition. The acrylic ester also contributes to the particularly good strength of adhesion of the composition to surfaces.

In a further embodiment of the UV-light-curable composition, the composition comprises as a further constituent:
6) an adhesion promoter, preferably a phosphate-methacrylate-oligomer, preferably a phosphate-methacrylate-oligomer having a functionality of 1.5. Even more preferably, constituent 6 is selected from Miramer SC 1400, Miramer A99 (products of Miwon Specialty Chemical Co., Ltd.) and Ebecryl 168 (product of Allnex GmbH, Germany). Constituent 6 acts as an adhesion promoter in the UV-light-curable composition; it gives the coating formed from the composition very good adhesion to the surface being coated.

The UV-light-curable composition of the invention preferably comprises no polyamine or monoamine containing an amino group reactive towards isocyanates or urethanes.

In a further embodiment of the UV-light-curable composition, the composition comprises as a further constituent:
7) at least one filler, preferably a sheet silicate and/or silica, more preferably talc (Mg₃[(OH)₂]Si₄O₁₀, magnesium silicate hydrate) and/or silica. These fillers are used to adjust the viscosity of the UV-light-curable composition. Preferably, the viscosity is adjusted such that the composition attains a consistency with which it can very easily be troweled onto a surface, levels to a uniform layer thickness, but nevertheless does not however run down an inclined or vertical surface before it has hardened.

Preferably, the UV-light-curable composition of the invention includes the constituents listed above in the following contents:
constituent 1a) the difunctional urethane acrylate oligomer diluted with a difunctional acrylate monomer: 20 to 35%, preferably 25 to 30%, more preferably 27 to 29%, based on the total weight of the composition; and/or
constituent 1b) the difunctional urethane acrylate oligomer diluted with a monofunctional acrylate monomer: 20 to 35%, preferably 25 to 30%, more preferably 26 to 28%, based on the total weight of the composition; and/or
constituent 2) the thiol-functionalized acrylate oligomer: 5 to 20%, preferably 10 to 19%, more preferably 16 to 17%; and/or
constituent 3) the at least one type I photoinitiator or the sum total of all type I photoinitiators: 0.01 to 10%, preferably 0.1 to 7%, more preferably 0.1 to 5%; and/or
constituent 4) the at least one colour-change indicator or the sum total of all colour-change indicators: 0.01 to 5%, preferably 0.01 to 2%, more preferably 0.05 to 1%; and/or
constituent 5) the acrylic ester: 8 to 20%, preferably 10 to 16%, more preferably 11 to 13%; and/or
constituent 6) the adhesion promoter: 1 to 10%, preferably 3 to 9%, more preferably 5 to 7%; and/or
constituent 7) the at least one filler or the sum total of all fillers: 1 to 10%, preferably 3 to 8%, more preferably 5 to 6%; and wherein the contents of the individual constituents are adjusted in respect of one another so that their sum comes to 100%. These percentages are percentages by weight.

Preferably, the UV-light-curable composition of the invention contains no trifunctional acrylates.

Preferably, the UV-light-curable composition of the invention is, in accordance with one of the preceding embodiments, solvent-free, i.e., it contains no organic or inorganic solvents. More preferably, solvents are present in a concentration of not more than 0.1%, more preferably of 0.01% to 0.1%. These percentages are percentages by weight or percentages by volume. In the UV-light-curable composition of the invention, the purpose of the constituents that are present in liquid form under standard conditions, for example reactive diluents, is to dissolve or disperse the other constituents. Once the composition has cured/polymerized, all originally liquid constituents will have been crosslinked in the resulting polymer matrix (polymer network). This has the advantage that the resulting polymer network contains no solvent. The presence of solvents in the resulting polymer matrix would be disadvantageous because in the event of high temperature fluctuations, to which a surface thus coated may be exposed, the polymer network/coating is exposed to additional stresses that reduce its stability.

Preferably, the UV-light-curable composition of the invention contains no silicon-containing compounds, i.e., no silanes, siloxanes or silicones, for example.

Preferably, the UV-light-curable composition of the invention is a troweling compound, more preferably a one-component troweling compound. Troweling compounds are easily applied to surfaces. They are particularly suitable for uneven, non-flat and/or irregularly shaped surfaces.

Unlike the customary two-component coating compounds, the present composition is preferably a one-component coating compound, more preferably a one-component troweling compound. This has the advantage that it is ready to use immediately after it has been prepared, whereas two-component systems must either be worked with in cartridges or must first be freshly mixed before use. With the commencement of mixing, polymerization/curing starts too. The working time of a two-component coating compound is therefore limited. Once a two-component has been mixed, any unused material will cure regardless and will need to be disposed of appropriately. By contrast, the one-component coating compound/one-component troweling compound of the invention has the advantage that any unused material left over after use can be stored further without it hardening and can be used further at a later time.

The UV-light-curable composition of the invention preferably has a pot life of unlimited length. The pot life is understood as meaning the duration of workability of reactive materials, for example curable coating compounds. The end of the pot life is marked by a sharp increase in viscosity that prevents it from being worked with further. In the context of the present invention, the pot life is understood as meaning the time between mixing the UV-light-curable composition and the end of its workability, i.e., the period of time during which the UV-light-curable composition can be withdrawn from a pot and worked with. After mixing, the UV-light-curable composition of the invention preferably has a pot life of unlimited length/remains indefinitely workable, provided it is stored under appropriate conditions, for example with exclusion of UV light. Under these conditions the composition of the invention too remains indefinitely storable and stable, without undergoing premature undesired hardening.

Preferably, the UV-light-curable composition of the invention can in a single coating cycle be applied to a surface and cured in a layer thickness of up to 5 mm, further preferably in a layer thickness of 1 μm to 5 mm, even further preferably from 80 μm to 5 mm, more preferably from 0.2 mm to 5 mm, even more preferably from 0.5 mm to 5 mm, additionally preferably from 1 mm to 5 mm, more additionally preferably from greater than 1 mm to equal to 5 mm, further preferably from 2 mm to 5 mm, even further preferably from greater than 2 mm to equal to 5 mm, most preferably from 3 mm to 5 mm. This was surprising, because conventional coating compounds can in one coating cycle be readily applied to a surface and cured in a layer thickness of only up to 1 mm. If higher layer thicknesses are required, it is necessary for more than one layer to be applied in separate coating cycles, which is laborious and time-consuming. In the UV-light-curable composition of the invention, the chosen acrylate compounds (constituents 1 or 1a, 1b; 2, 5), especially the thiol-functionalized acrylate oligomer (constituent 2), in the contents thereof specified above, have the effect of making it possible in the coating step for the composition to be very readily applied to a surface and cured even in high layer thicknesses of up to 5 mm.

In a second aspect the invention relates to a process for producing the UV-light-curable composition of the invention, the process comprising the steps of:
i) charging a container with constituents 1 and 2, preferably constituents 1a, 1b and 2; and optionally constituents 5 and/or 6 and mixing the constituents until a mixture i) has formed, preferably a homogeneous mixture i); wherein mixing is carried out preferably at a shear rate of from 12 m/s to 18 m/s, more preferably from 14 m/s to 16 m/s; and/or wherein mixing is carried out preferably for 10 to 30 minutes, more preferably for 20 minutes;
ii) adding at least one filler according to constituent 7 to the mixture i) and dispersing the at least one filler in the mixture i) until a dispersion ii) has formed; wherein the dispersing is carried out preferably at a high shear rate, more preferably at a high shear rate of from 19 m/s to 26 m/s, more preferably at 21 m/s to 24 m/s; and/or wherein the dispersing is carried out preferably for 10 to 30 minutes, more preferably for 20 minutes; and/or wherein the temperature of the mixture i) during dispersing is preferably from 40° C. to 70° C., more preferably from 50° C. to 65° C.;
iii) adding at least one type I photoinitiator according to constituent 3 to the dispersion ii), with stirring, until a mixture iii) has formed; wherein stirring is carried out preferably at a shear rate of from 12 m/s to 16 m/s, more preferably at 14 m/s; and/or wherein stirring is carried out preferably for 5 to 30 minutes, more preferably for 10 to 20 minutes;
iv) adding at least one colour-change indicator according to constituent 4 to the mixture iii), with stirring, until a mixture iv) has formed; wherein stirring is carried out preferably at a shear rate of from 12 m/s to 16 m/s, more preferably at 14 m/s; and/or wherein stirring is carried out preferably for 1 to 10 minutes, more preferably for 4 to 6 minutes; and
v) deaerating the mixture iv) under reduced pressure and with stirring; wherein stirring is carried out preferably at a shear rate of from 12 m/s to 18 m/s, more preferably from 14 m/s to 16 m/s; and/or wherein stirring is carried out preferably for 20 to 40 minutes, more preferably for 25 to 35 minutes.

The steps of the production process of the invention are also referred to hereinbelow as production steps. During the mixing of the constituents in production step i), the temperature of the mixture i) may rise. The temperature must not rise above 60° C. here.

During the production steps i) to iv), the various constituents of the composition of the invention are mixed together, dispersed and stirred, this being accompanied by the introduction of air into the composition. The oxygen present therein has an adverse effect on the free-radical polymerization of the composition carried out subsequently. Therefore, the mixture iv) is deaerated in a production step v), in which the composition also undergoes removal of oxygen. The reduced pressure generated for this purpose is preferably a pressure of less than 1 bar, more preferably a pressure of 0.5 bar to 0.9 bar. The deaeration also advantageously ensures that no gas inclusions develop in the coating/polymer network formed. Gas inclusions in the coating/polymer network formed are disadvantageous, since they form pores therein, which act as defects and would need to be repaired subsequently.

In the production process of the invention and the UV-light-curable composition of the invention, the at least one type I photoinitiator preferably comprises two or more different type I photoinitiators, wherein two or more different type I photoinitiators are more preferably dissolved in one another before being added to the dispersion ii) according to step iii), and/or wherein the temperature of the two or more different type I photoinitiators during dissolution in one another is preferably 30° C. to 50° C., more preferably 40° C., and/or wherein the dissolution in one another takes place preferably overnight, more preferably for 16 hours.

The two or more different type I photoinitiators are selected preferably from the group comprising α-hydroxyaryl ketone, acylphosphine oxide and acyl phosphinate, more preferably 2-hydroxy-2-methyl-1-phenylpropanone, ethyl (2,4,6-trimethylbenzoyl)phenylphosphinate and phenylbis(2,4,6-trimethylbenzoyl)phosphine oxide; particularly preferably ethyl (2,4,6-trimethylbenzoyl)phenylphosphinate and phenylbis(2,4,6-trimethylbenzoyl)phosphine oxide. The type I photoinitiators ethyl (2,4,6-trimethylbenzoyl)phenylphosphinate and phenylbis(2,4,6-trimethylbenzoyl)phosphine oxide are particularly well suited for dissolving in one another, since phenylbis(2,4,6-trimethylbenzoyl)phosphine oxide is highly soluble in ethyl (2,4,6-trimethylbenzoyl)phenylphosphinate. The solution of phenylbis(2,4,6-trimethylbenzoyl)phosphine oxide in ethyl (2,4,6-trimethylbenzoyl)phenylphosphinate accounts for a content preferably of from 2% by weight to 5% by weight in the UV-light-curable composition of the invention, more preferably of from 3% by weight to 4% by weight. More preferably, ethyl (2,4,6-trimethylbenzoyl)phenylphosphinate and phenylbis(2,4,6-trimethylbenzoyl)phosphine oxide are present in a ratio to one another of 24:1. This is a ratio by weight. In step iii) of the production process of the invention, the solution of phenylbis(2,4,6-trimethylbenzoyl)phosphine oxide in ethyl (2,4,6-trimethylbenzoyl)phenylphosphinate is added preferably in this content range, more preferably in the specified ratio.

More preferably, the UV-light-curable composition of the invention contains the type I photoinitiator 2-hydroxy-2-methyl-1-phenylpropanone in a content of 0.1% by weight to 1.0% by weight, even more preferably in a content of 0.2% by weight to 0.6% by weight. In step iii) of the production process of the invention, the type I photoinitiator 2-hydroxy-2-methyl-1-phenylpropanone may be added in this content range.

In a third aspect the invention relates to a use of the UV-light-curable composition of the invention as a coating compound, preferably as a troweling compound; the UV-light-curable composition preferably being used for the coating of surfaces; and/or the UV-light-curable composition more preferably being applied to a surface by troweling. Because the UV-light-curable composition is used preferably for the coating of surfaces, it is also referred to as a coating compound. Because the UV-light-curable composition is more preferably applied to a surface using a trowel and has the appropriate consistency for this, it is also referred to as a troweling compound.

The invention further relates to a use of the UV-light-curable composition of the invention for the coating of surfaces. The surfaces are selected preferably from the group comprising surfaces of plastics, surfaces of glass-fibre-reinforced plastics (GRPs), surfaces of carbon-fibre-reinforced plastics (CRPs), surfaces of rotor blades of wind turbines, surfaces of metals, and surfaces of wood; more preferably from surfaces of plastics, surfaces of glass-fibre-reinforced plastics, surfaces of carbon-fibre-reinforced plastics, surfaces of rotor blades of wind turbines, and surfaces of metals; particularly preferably from surfaces of glass-fibre-reinforced plastics, surfaces of carbon-fibre-reinforced plastics, and surfaces of rotor blades of wind turbines. Rotor blades of wind turbines generally comprise glass-fibre-reinforced plastics and carbon-fibre-reinforced plastics. It has surprisingly been found that after the coating of a surface and curing thereon the UV-light-curable composition of the invention has very good adhesion on said surface. This is particularly true of the plastic and metal surfaces mentioned. In addition, the UV-light-curable composition of the invention also shows high strength of adhesion to further layers applied thereon.

The UV-light-curable composition of the invention is used preferably in the construction and repair of wind turbines, in automobile construction, and in yacht construction; more preferably for coating at the factory of and/or for repair of rotor blades of wind turbines. This can be ascribed firstly to the high strength of adhesion of the composition to the abovementioned surface materials and to further coatings. Moreover, a coating with the UV-light-curable composition of the invention meets further requirements important for use in the areas mentioned above, such as an appropriate viscosity, being able to undergo easy and even application to surfaces, a long pot life and working time, a short time until the coating has cured and can undergo further working or have further coatings applied, the possibility of high layer thicknesses of up to 5 mm, no inclusions of solvents, and very stable to the effects of weathering and ageing. Weathering and ageing are influenced by factors such as resistance to high humidity, precipitation, sunlight, especially the UV component, and temperature fluctuations. Under corresponding test conditions (DIN EN 13523-27, DIN EN ISO 6270-2, DIN EN ISO 16474-3, DIN EN ISO 16474-3, ASTM 4587-5, DIN EN ISO 16474-2), coatings with the UV-light-curable composition of the invention show high strength of adhesion to the coated surface, without the formation of air bubbles or cracks and without flaking.

In a fourth aspect the invention relates to a process for coating a surface, the process comprising the steps of:
I) providing a UV-light-curable composition of the invention;
II) applying the composition to a surface, preferably using a trowel, until a coloured layer of the composition has formed on the surface;
III) treating the coloured layer with UV light, preferably with a handheld UV lamp, more preferably with a handheld LED UV lamp, to cure the composition until the layer undergoes a change in colour to completely colourless, thereby indicating the formation of a cured layer, preferably a completely cured layer;
IV) optionally further working of the cured layer, preferably by sanding;
V) optionally repeating steps II) to IV) until at least one further cured layer has formed;
VI) optionally further working and applying of further layers, the further layers being different from the cured layers from the preceding steps, and/or the further layers being selected preferably from paints, water-based paints, emulsion paint, topcoat and leading edge protection.

The use according to the invention may encompass the same process steps that are elucidated in more detail herein for the process. Further features of use are defined elsewhere herein.

The steps of the coating process of the invention are carried out preferably in the stated order. The steps of the coating process of the invention are also referred to hereinbelow as coating steps. A coating cycle is for the purposes of the present invention understood as meaning a sequence of coating steps comprising steps I) to IV) or a step of providing a coating compound, for example the UV-light-curable composition of the invention, a step of applying the coating compound to a surface, a step of treating the applied layer with UV radiation and optionally a step of further working of the layer treated with UV radiation.

Between coating steps I) and II) it is possible for further steps to be optionally included, for example
I.I) optionally stirring of the composition.

The performance of such an optional coating step can be advantageous when the UV-light-curable composition of the invention has been stored for a long time before being used for coating.

In coating step III) the coloured layer of the UV-light-curable composition is treated with UV radiation. UV radiation in the wavelength range from 200 nm to 405 nm is preferably used. In this wavelength range, good and rapid curing of the composition is achieved. The UV radiation source used can be a mercury-vapour lamp or a LED UV emitter. Mercury-vapour lamps emit UV radiation in the wavelength range from 200 nm to 400 nm, LED UV emitters from 365 nm to 405 nm. It has been found to be advantageous to use the mentioned UV radiation sources in the form of handheld devices, i.e., handheld UV devices. These may be used both for the treatment of large surfaces and for the treatment of very irregularly shaped surfaces, since they allow UV radiation to be optimally applied also to structures that are otherwise difficult to reach. Such handheld devices are also very easy to operate. Particularly advantageous are handheld LED UV devices that provide UV radiation with high energy density in an energy-saving manner, thereby helping achieve rapid and even curing of the composition of the invention.

In coating step III), the output of the handheld UV device is preferably from 10% to 100%, more preferably from 40% to 100%, most preferably from 50% to 90%.

In an optional coating step IV), the layer of the composition of the invention cured in coating step III) can undergo further working. Further working preferably includes sanding of the cured layer. Sanding helps ensure that a subsequently applied further layer develops good adhesion to the preceding layer.

In the process of the invention, it is however also possible for a further layer of the composition of the invention in accordance with optional coating step V) or a further layer of a different radiation-curable coating compound in accordance with optional coating step VI), for example a radiation-curable paint, to be applied to the already cured layer without the already cured layer having first undergone further working. Optional coating step V) may be carried out one or more times, thereby enabling one or more further layers of the composition of the invention to be applied to the already cured layer. All such further layers can in each case be applied without the previous layer having first undergone further working. The coating step comprising further working of the already cured layer can thus be omitted, which affords advantageous savings of labour and work time. This allows process times in the production and repair of coated products to be massively shortened, which is advantageous.

In a further embodiment of the process of the invention, the output of the handheld UV device/the lamp output of the UV radiation source in coating step III) can preferably be reduced, for example to 40-60%, more preferably to 50%. The cured layer in coating step III) in that case does not undergo complete curing, i.e., the crosslinking of the cured layer is then incomplete. After the optional application of a further layer and during the curing thereof by treatment with UV radiation, the incompletely cured layer from coating step III) and the further layer cure together, which surprisingly results in outstanding adhesion of the two layers to one another.

With the process of the invention it is however not a prerequisite for more than one layer of the composition of the invention to be applied to a surface in order for said surface to be coated. After all, it is possible with the composition of the invention and the process of the invention to achieve high layer thicknesses of up to 5 mm with a single coating cycle, which is more than sufficient for most uses. This too affords advantageous savings of labour and work time.

In an optional coating step VI), further layers can be applied onto the layer(s) already applied according to coating steps I) to V), these further layers being different from the cured layer(s) from the preceding steps. The further layers may be a single layer or more than one layer. The further layers are selected preferably from paints, water-based paints, emulsion paint, topcoat and leading edge protection (LEP). LEP paints are important primarily in the construction and repair of rotor blades for wind turbines. LEP paints are applied to the edges or rotor blades to protect them from the erosive effects of shear forces and weathering.

In the coating process of the invention, the curing of the composition in coating step III) in an effective range of UV radiation takes place preferably within seconds, further preferably within at least 20 seconds, even further preferably within from 20 seconds to 5 minutes, more preferably from 20 seconds to 2 minutes, particularly preferably from 20 seconds to 90 seconds. Immediately thereafter, the cured layer can optionally undergo further working in accordance with coating step IV) and/or given a further layer in accordance with coating steps V) and/or VI). A standard commercial coating compound or troweling compound needs at least 30 minutes to cure and before this layer can undergo further working, for example sanding, or be coated with a further layer. In the production and repair of coated products, this gives rise to disadvantageously long standing times or wait times. The UV-light-curable composition of the invention and the coating process of the invention offer a distinct time advantage by comparison.

In the coating process of the invention, it is preferable that no layer of a granular material is applied on top of applied layers, and not after coating steps II), III), IV), and/or V) in particular.

In the coating process of the invention, the surface is selected preferably from the group comprising surfaces of plastics, surfaces of glass-fibre-reinforced plastics (GRPs), surfaces of carbon-fibre-reinforced plastics (CRPs), surfaces of rotor blades of wind turbines, surfaces of metals, and surfaces of wood; more preferably from surfaces of plastics, surfaces of glass-fibre-reinforced plastics, surfaces of carbon-fibre-reinforced plastics, surfaces of rotor blades of wind turbines, and surfaces of metals; particularly preferably from surfaces of glass-fibre-reinforced plastics, surfaces of carbon-fibre-reinforced plastics, and surfaces of rotor blades of wind turbines. Rotor blades of wind turbines generally comprise glass-fibre-reinforced plastics and carbon-fibre-reinforced plastics.

In a fifth aspect the invention relates to a coated product, wherein the coated product includes a surface, and to a cured layer of the UV-light-curable composition of the invention applied thereon, and/or wherein the cured layer has a layer thickness of up to 5 mm; and/or wherein the surface is selected preferably from the group comprising surfaces of plastics, surfaces of glass-fibre-reinforced plastics (GRPs), surfaces of carbon-fibre-reinforced plastics (CRPs), surfaces of rotor blades of wind turbines, surfaces of metals, and surfaces of wood; and/or wherein the coated product has been produced preferably according to the coating process of the invention. The cured layer is preferably a layer applied in a single coating cycle. Further preferably, the cured layer has a layer thickness of 1 μm to 5 mm, even further preferably from 80 μm to 5 mm, more preferably from 0.2 mm to 5 mm, even more preferably from 0.5 mm to 5 mm, additionally preferably from 1 mm to 5 mm, more additionally preferably from greater than 1 mm to equal to 5 mm, further preferably from 2 mm to 5 mm, even further preferably from greater than 2 mm to equal to 5 mm, most preferably from 3 mm to 5 mm. The product/surface is preferably a shaped article. The product/surface is preferably not a film.

### Examples

Further advantages, characteristics and features of the present invention will be apparent in the detailed description of exemplary embodiments that follows. The invention is however not limited to these exemplary embodiments.

1. Composition for the Coating of Surfaces

The following composition of the invention was used as a troweling compound for the coating of various surfaces in the examples that follow:

| Constituents | | Amount/% by weight |
|---|---|---|
| 1a | Miramer DP 408 | 27-29% |
| 1b | Miramer UA 5216 | 26-28 |
| 2 | Miramer ES4420NT | 16-17 |
| 5 | Miramer M122 | 11-13 |
| 6 | Miramer SC 1400 | 5-7 |
| 7 | Talc Mistron-Monomix G | 5-6 |
| 7 | Aerosil 300 | 5-6 |
| 3 | Omnirad 1173 | 0.2-0.6 |
| 3 | Lucirin TPO-L/Keycure PI-981 (24:1) | 3-4 |
| 4 | CR234-BT2B or CR236 (UV indicator) | 0.05-1% |

The composition was produced in accordance with the process of the invention (production process) and was used for coating a surface in accordance with the process of the invention (coating process).

2. Determination of Adhesive Strength

After a surface had been coated with the composition of the invention specified in example 1 and this had cured, a pull-off test in accordance with DIN EN ISO 4624:2016 was carried out to determine the adhesive strength of the layer of the composition on the surface. This was done by gluing round test dollies (aluminium test dollies, diameter 2 cm) to the resulting coating using the adhesive Loctite EA 3423 A&B Hysol. No sooner than 24 hours later, the dollies were pulled off with a load increase of 0.2 MPa/s using the PosiTest AT-A test device from DeFelsko while measuring the force needed to remove a dolly. This force is a measure of the strength of adhesion of the coating on the coated surface. The more of this force that needs be applied to remove a dolly, the higher the strength of adhesion of the coating to the surface.

The adhesive strength was additionally assessed on the basis of the break pattern arising from pulling off the dolly. After gluing on a dolly, the following coating structure was obtained: (A) surface material, (B) layer of the composition of the invention (troweling compound), (Y) layer of adhesive, (Z) test dolly. After pulling off the test dolly, it is possible for parts or the entire layer of adhesive to have remained stuck to the surface of the dolly, parts or the entire layer of the troweling compound, or parts or a continuous layer of the surface material.

3. Coating of a Plastic Surface with the Composition of the Invention

The plastic surface used was a glass-fibre-reinforced plastic plate with polyester infusion resin. The plate was cleaned and a trowel was used to apply a 2 mm thick layer of the troweling compound (see example 1) to an area of about 7 cm×55 cm. The layer of the troweling compound was treated with a handheld LED UV lamp for 60 seconds to cure it. The output of the handheld LED UV lamp was set to 90% for this. At 100% output the handheld LED UV lamp as an output of 30 W. This afforded a colourless, solid, tack-free layer that was of uniform thickness, level and dry. After curing, the thickness of the coating obtained was 2 mm, thus no shrinkage of the layer occurred as a result of curing.

After curing, four of the test dollies were glued to the coating obtained. 72 hours later, the dollies were pulled off while measuring the force needed to remove a dolly, as described in example 2. The adhesive strengths and break patterns obtained for the individual dollies are summarized in Table 1.

TABLE 1

| Dolly | Adhesive strength/MPa | A/% |
|---|---|---|
| 1 | 4.26 | 100 |
| 2 | 4.26 | 100 |
| 3 | 4.49 | 100 |
| 4 | 6.74 | 100 |

All break patterns show a failure of cohesion in the material of the plastic plate (A). That is to say, on each dolly the entire layer of the adhesive remained stuck, the entire layer of the troweling compound and a continuous layer of the surface material. The adhesive strength of the troweling compound was thus sufficiently great that it was not possible to remove the layer of the troweling compound from the surface of the plastic plate at all. Instead, the layer of the plastic plate fractured parallel to the plane of the layer. For this break to occur, the forces listed in Table 1 were necessary. The adhesive strength of the troweling compound on the surface of the plastic plate was thus significantly higher than 4 to 6 MPa, which represents very good adhesive strength.

4. Coating of a Plastic Surface with the Composition of the Invention

The plastic surface used was two glass-fibre-reinforced plastic plates with epoxy infusion resin. The plates were cleaned and a trowel was used to apply a 2 mm thick layer of the troweling compound (see example 1) to the surface of each plate. On plastic plate 1, the layer of the troweling compound was treated with a handheld LED UV lamp for 30 seconds to cure it and on plastic plate 2 this was done for 40 seconds. The output of the handheld LED UV lamp was set to 90% for this. This afforded colourless, solid, tack-free layers that were of uniform thickness, level and dry. After curing, the thickness of the coating obtained was 2 mm, thus no shrinkage of the layers occurred as a result of curing.

After curing, for determination of the adhesive strength of the layer of the troweling compound on the plastic plates, two of the test dollies were in each case glued to the coating obtained. 24 hours later, the dollies were pulled off and the adhesive strength determined as described in example 2. The adhesive strengths and break patterns obtained for the individual dollies are summarized in Table 2.

TABLE 2

| | Adhesive strength/MPa | A/B/% | B/% | Y/% |
|---|---|---|---|---|
| Plastic plate 1: | | | | |
| Dolly 1 | 13.43 | 100 | — | — |
| Dolly 2 | 12.94 | 100 | — | — |
| Plastic plate 2: | | | | |
| Dolly 3 | 13.25 | 100 | — | — |
| Dolly 4 | 15.24 | — | 10 | 90 |

The resulting coating of the invention exhibited extremely good adhesive strength of more than 12 MPa on the surface of the glass fibre-reinforced plastic plates. The break patterns of dollies 1 to 3 showed a failure of adhesion between the material of the plastic plate (A) and the coating with the troweling compound (B) (column A/B in Table 2), i.e., the entire layer of the adhesive (Y) and the entire layer of the troweling compound (B) remained stuck to the dollies. The troweling compound of the invention thus had an adhesive strength of more than 12 MPa to the surface of the glass fibre-reinforced plastic plates, which is an extremely good adhesive strength.

The break pattern of dolly 4 showed a 10% failure of cohesion in the material of the coating with troweling compound (B) (column B in Table 2) and a 10% failure of cohesion in the material of the adhesive (Y) (column Y in Table 2). Thus, a large part of the layer of the adhesive (Y) and a very small part of the layer of the troweling compound (B) remained stuck to the dolly. The troweling compound of the invention thus had a strength of adhesion to the surface of the glass fibre-reinforced plastic plates that was so high that it almost could not be removed from the plastic plate.

5. Coating of a Plastic Surface with the Composition of the Invention

The plastic surface used was an acrylonitrile-butadiene-styrene plate (ABS plate). The surface of the plate was sanded and cleaned. A trowel was used to apply a 2 mm thick layer of the troweling compound (see example 1). The layer of the troweling compound was treated with a handheld LED UV lamp for 20 seconds to cure it. The output of the handheld LED UV lamp was set to 90% for this. This afforded a colourless, solid, tack-free layer that was of uniform thickness, level and dry.

After curing, two of the test dollies were glued to the coating obtained. 24 hours later, the dollies were pulled off and the adhesive strength of the coating obtained measured as described in example 2. The adhesive strengths and break patterns obtained are summarized in Table 3.

TABLE 3

| Dolly | Adhesive strength/MPa | A/% | A/B/% |
|---|---|---|---|
| 1 | 5.44 | — | 100 |
| 2 | 5.56 | 100 | — |

The resulting coating of the invention exhibited very good adhesive strength of more than 5 MPa on the surface of the ABS plate. Dolly 1 showed a failure of adhesion between the material of the ABS plate (A) and the coating with the troweling compound (B) (column A/B in Table 3), i.e., the entire layer of the adhesive (Y) and the entire layer of the troweling compound (B) remained stuck to dolly 1. The troweling compound of the invention thus had an adhesive strength of more than 5 MPa to the surface of the ABS plate, which is a very good adhesive strength.

Dolly 2 showed a 100% failure of cohesion of the ABS plate (A) (column A in Table 3), i.e., the entire layer of the adhesive (Y), the entire layer of the troweling compound (B) and a continuous layer of the surface material of the ABS plate (A) remained stuck to dolly 2. In the region of the surface of the ABS plate covered by dolly 2 that had been coated according to the invention, the troweling compound of the invention thus had a strength of adhesion to the surface of the ABS plate that was so high that it could not be removed from the ABS plate. Instead, the material of the ABS plate fractured parallel to the plane of the layer.

6. Coating of a Metal Surface with the Composition of the Invention

The metal surfaces uses were a sendzimir-galvanized steel sheet, a degreased steel sheet, a zinc-phosphate-coated steel sheet (26S/6800/OC), and a chromated, anodized aluminium sheet. The surfaces of the metal sheets had been cleaned. A trowel was used to apply a 2 mm thick layer of the troweling compound (see example 1). The layer of the troweling compound was treated with a handheld LED UV lamp for 20 seconds to cure it. The output of the handheld LED UV lamp was set to 90% for this. This afforded colourless, solid, tack-free layers on the sheets that were of uniform thickness, level and dry.

After curing, a test dolly was in each case glued to the coating obtained on each sheet. 24 hours later, the dollies were pulled off and the adhesive strength of the coating obtained determined as described in example 2. The adhesive strengths and break patterns obtained are summarized in Table 4.

TABLE 4

| | | Adhesive | | | | |
|---|---|---|---|---|---|---|
| Dolly | Sheet | strength/MPa | A/B/% | B/% | Y/% | Y/Z/% |
| 1 | Sendzimir- | 12.40 | 20 | — | 70 | 10 |
| | galvanized steel | | | | | |
| | sheet | | | | | |
| 2 | Degreased steel | 7.74 | 20 | — | 80 | — |
| | sheet | | | | | |
| 3 | Zinc-phosphate- | 12.94 | 40 | 60 | — | — |
| | coated steel sheet | | | | | |
| 4 | Aluminium sheet | 10.87 | 90 | 10 | — | — |

The resulting coatings of the invention exhibited extremely good adhesive strengths of in some cases more than 12 MPa on the surface of the metal sheets. Dolly 1 showed a 20% failure of adhesion between the material of the sendzimir-galvanized steel sheet (A) and the coating with the troweling compound (B) (column A/B in Table 4), a 70% failure of adhesion between the adhesive (Y) and the coating with the troweling compound (B) (column Y in Table 4) and a 10% failure of adhesion between the adhesive (Y) and the test dolly (Z) (column Y/Z in Table 4). Thus, a large part of the adhesive (Y) and only a small part of the layer of the troweling compound (B) remained stuck to dolly 1. A large part of the troweling compound of the invention thus had a strength of adhesion to the surface of the steel sheet that was so high that it could not be removed from the sendzimir-galvanized steel sheet.

Dolly 2 showed a 20% failure of adhesion between the material of the degreased steel sheet (A) and the coating with the troweling compound (B) (column A/B in Table 4) and an 80% failure of adhesion between the adhesive (Y) and the coating with the troweling compound (B) (column Y in Table 4). Thus, the entire layer of the adhesive (Y) and only a small part of the layer of the troweling compound (B) remained stuck to dolly 2. A large part of the troweling compound of the invention thus had a strength of adhesion to the surface of the steel sheet that was so high that it could not be removed from the degreased steel sheet.

Dolly 3 showed a 40% failure of adhesion between the material of the zinc-phosphate-coated steel sheet (A) and the coating with the troweling compound (B) (column A/B in Table 4) and a 60% failure of cohesion in the coating (B) (column B in Table 4). Thus, the entire layer of the adhesive (Y) and only part of the layer of the troweling compound (B) remained stuck to dolly 3. The other part of the troweling compound of the invention thus had a strength of adhesion to the surface of the zinc-phosphate-coated steel sheet that was so high that it could not be removed from the degreased steel sheet.

Dolly 4 showed a 90% failure of adhesion between the material of the aluminium sheet (A) and the coating with the troweling compound (B) (column A/B in Table 4) and a 10% failure of cohesion in the coating (B) (column B in Table 4). Thus, the entire layer of the adhesive (Y) and a large part of the layer of the troweling compound (B) remained stuck to dolly 4. However, a force of more than 10 MPa was required to detach this large part of the layer of the troweling compound, which means that the layer of the troweling compound of the invention had extremely good strength of adhesion to the surface of the aluminium sheet.

7. Applying a Further Layer to a Coating with the Composition of the Invention

Coatings with the composition of the invention were applied to glass-fibre-reinforced plastic sheets (GRP sheets) as described in example 3. The coating was here applied to plastic plate 1 with a thickness of approximately 2 mm and to plastic plate 2 with a thickness of approximately 1 mm. This afforded colourless, solid, tack-free layers on the plates that were of uniform thickness, level and dry.

After curing, the coatings obtained were sanded, cleaned, and coated with a layer of a LEP paint (LEP=leading edge protection, Bergolin LEP 6D1100, RAL7035), as used for edge protection on the rotor blades of wind turbines.

After the LEP paint had cured, on plastic plate 1 two test dollies were glued to the LEP paint and on plastic plate 2 three test dollies. In a departure from example 2, this afforded the following coating structure: (A) surface material, (B) layer of the composition of the invention (troweling compound), (C) layer of LEP paint, (Y) layer of adhesive, (Z) test dolly. 24 hours after gluing on the test dollies, these were pulled off and the adhesive strength between the coating obtained and the LEP paint was measured as described in example 2. The adhesive strengths and break patterns obtained are summarized in Table 5.

TABLE 5

| | Adhesive strength/MPa | A/B/% | B/C/% | C/% |
|---|---|---|---|---|
| Plastic plate 1 | | | | |
| Dolly 1 | 12.86 | 100 | — | — |
| Dolly 2 | 13.07 | 100 | — | — |
| Plastic plate 2 | | | | |
| Dolly 3 | 11.73 | 55 | 45 | — |
| Dolly 4 | 9.29 | 10 | 40 | 50 |
| Dolly 5 | 12.84 | 100 | — | — |

The resulting coatings of the invention exhibited extremely good strengths of adhesion to the LEP paint of 9 MPa to more than 13 MPa. Dollies 1, 2, and 5 showed a failure of adhesion between the material of the GRP plates (A) and the coating with the troweling compound (B) (column A/B in Table 5), i.e., the entire layer of the adhesive (Y), the entire layer of the LEP paint (C) and the entire layer of the troweling compound (B) remained stuck to the dollies. The troweling compound of the invention thus had an adhesive strength of more than 12 MPa to the surface of the GRP plates. No break between the layer of the LEP paint and the layer of the troweling compound of the invention occurred when a force of more than 12 MPa was acting on the dolly. There was thus extremely good strength of adhesion between the layer of the LEP paint and the layer of the troweling compound of the invention and also between the surface of the GRP plates and the troweling compound of the invention.

Dolly 3 showed a 55% failure of adhesion between the material of the GRP plate (A) and the coating with the troweling compound (B) (column A/B in Table 5) and a 45% failure of adhesion between the coating with the troweling compound (B) and the layer of the LEP paint (C) (column B/C in Table 5). Thus, the entire layer of the adhesive (Y), the entire layer of the LEP paint (C) and part of the layer of the troweling compound (B) remained stuck to dolly 3. About half of the layer of the troweling compound (B) thus remained stuck to the material of the GRP plate and the other half of the layer of the troweling compound (B) to the layer of the LEP paint. The adhesion of the troweling compound of the invention was similarly high to the material of the GRP plate and to the layer of the LEP paint.

Dolly 4 showed a 10% failure of adhesion between the material of the GRP plate (A) and the coating with the troweling compound (B) (column A/B in Table 5), a 40% failure of adhesion between the coating with the troweling compound (B) and the layer of the LEP paint (C) (column B/C in Table 5) and a 50% failure of cohesion in the layer of the LEP paint (column C in Table 5). Thus, the entire layer of the adhesive (Y), the entire layer of the LEP paint (C) and part of the layer of the troweling compound (B) remained stuck to dolly 4. About 50% of the layer of the troweling compound thus maintained attachment to the layer of the LEP paint. This means that, as with test dolly 3, the adhesion of the troweling compound of the invention was similarly high to the material of the GRP plate and to the layer of the LEP paint.

Although the present invention has been described in detail on the basis of the exemplary embodiments, it will be self-evident to those skilled in the art that the invention is not limited to these exemplary embodiments but, rather, that variants are possible in which individual features may be omitted or different combinations of the presented individual features realized, provided the scope of protection of the appended claims is not departed from. The present disclosure encompasses all combinations of the individual features presented.

What is claimed is:

1. A UV-light-curable composition comprising the following constituents:
1) at least one difunctional urethane acrylate oligomer, preferably aliphatic, diluted with a reactive diluent, preferably an acrylate monomer;
2) a thiol-functionalized acrylate oligomer;
3) at least one type I photoinitiator activatable with UV light; and
4) at least one colour-change indicator that upon irradiation with UV light changes from coloured to colourless.

2. The composition according to claim 1, wherein the at least one difunctional urethane acrylate oligomer according to constituent 1 comprises at least two difunctional urethane acrylate oligomers selected from the group consisting of:
1a) a difunctional urethane acrylate oligomer, preferably aliphatic, diluted with a difunctional acrylate monomer, preferably dipropylene glycol diacrylate; and
1 b) a difunctional urethane acrylate oligomer, preferably aliphatic, diluted with a monofunctional acrylate monomer, preferably isobornyl acrylate,
wherein the urethane acrylate oligomers according to constituents 1a and 1 b are preferably different from one another.

3. The composition according to claim 1, wherein the at least one type I photoinitiator according to constituent 3 is selected from the group consisting of α-hydroxyaryl ketone, acyl phosphine oxide, acyl phosphinate, and a mixture thereof, preferably 2-hydroxy-2-methyl-1-phenylpropanone, ethyl (2,4,6-trimethylbenzoyl)phenylphosphinate, phenylbis(2,4,6-trimethylbenzoyl)phosphine oxide and a mixture thereof.

4. The composition according to claim 1, wherein the colour-change indicator according to constituent 4 is selected from the group consisting of CR234-BT2B, CR234, CR234B1, CR234BT1, CR236, CR234-R33, and CR234-V4; more preferably CR234-BT2B and CR236.

5. The composition according to claim 2, wherein the constituents have the following contents in the composition:
1a) the difunctional urethane acrylate oligomer diluted with a difunctional acrylate monomer: 20 to 35%, preferably 25 to 30%, more preferably 27 to 29%, based on the total weight of the composition; and/or
1 b) the difunctional urethane acrylate oligomer diluted with a monofunctional acrylate monomer: 20 to 35%, preferably 25 to 30%, more preferably 26 to 28%, based on the total weight of the composition; and/or
2) the thiol-functionalized acrylate oligomer: 5 to 20%, preferably 10 to 19%, more preferably 16 to 17%, and/or 3) the at least one type I photoinitiator or the sum total of all type I photoinitiators: 0.01 to 10%, preferably 0.1 to 7%, more preferably 0.1 to 5%; and/or
4) the at least one colour-change indicator or the sum total of all colour-change indicators: 0.01 to 5%, preferably 0.01 to 2%, more preferably 0.05 to 1%; and/or
5) the acrylic ester: 8 to 20%, preferably 10 to 16%, more preferably 11 to 13%; and/or
6) the adhesion promoter: 1 to 10%, preferably 3 to 9%, more preferably 5 to 7%; and/or
7) the at least one filler or the sum total of all fillers: 1 to 10%, preferably 3 to 8%, more preferably 5 to 6%; and
wherein the contents of the individual constituents are adjusted in respect of one another so that their sum comes to 100%.

6. The composition according to claim 1, wherein the composition can in a single coating cycle be applied to a surface and cured in a layer thickness of up to 5 mm, preferably in a layer thickness of 1 μm to 5 mm, further preferably from 80 μm to 5 mm, more preferably from 0.2 mm to 5 mm, even more preferably from 0.5 mm to 5 mm, additionally preferably from 1 mm to 5 mm, more additionally preferably from greater than 1 mm to equal to 5 mm, further preferably from 2 mm to 5 mm, even further preferably from greater than 2 mm to equal to 5 mm, most preferably from 3 mm to 5 mm.

7. A process for producing a UV-light-curable composition according to claim 5, the process comprising the steps of:
i) charging a container with constituents 1 and 2, preferably constituents 1a, 1b and 2; and optionally constituents 5 and/or 6 and mixing the constituents until a mixture i) has formed, preferably a homogeneous mixture i); wherein mixing is carried out preferably at a shear rate of from 12 m/s to 18 m/s, more preferably from 14 m/s to 16 m/s; and/or wherein mixing is carried out preferably for 10 to 30 minutes, more preferably for 20 minutes;
ii) adding at least one filler according to constituent 7 to the mixture i) and dispersing the at least one filler in the mixture i) until a dispersion ii) has formed; wherein the dispersing is carried out preferably at a high shear rate, more preferably at a high shear rate of from 19 m/s to 26 m/s, more preferably at 21 m/s to 24 m/s; and/or wherein the dispersing is carried out preferably for 10 to 30 minutes, more preferably for 20 minutes; and/or wherein the temperature of the mixture i) during dispersing is preferably from 40° C. to 70° C., more preferably from 50° C. to 65° C.;
iii) adding at least one type I photoinitiator according to constituent 3 to the dispersion ii), with stirring, until a mixture iii) has formed; wherein stirring is carried out preferably at a shear rate of from 12 m/s to 16 m/s, more preferably at 14 m/s; and/or wherein stirring is carried out preferably for 5 to 30 minutes, more preferably for 10 to 20 minutes;
iv) adding at least one colour-change indicator according to constituent 4 to the mixture iii), with stirring, until a mixture iv) has formed; wherein stirring is carried out preferably at a shear rate of from 12 m/s to 16 m/s, more preferably at 14 m/s; wherein stirring is carried out preferably for 1 to 10 minutes, more preferably for 4 to 6 minutes; and
v) deaerating the mixture iv) under reduced pressure and with stirring; wherein stirring is carried out preferably at a shear rate of from 12 m/s to 18 m/s, more preferably from 14 m/s to 16 m/s; and/or wherein stirring is carried out preferably for 20 to 40 minutes, more preferably for 25 to 35 minutes.

8. The process according to claim 7 for producing a composition, wherein the at least one type I photoinitiator comprises two or more different type I photoinitiators, wherein two or more different type I photoinitiators are preferably dissolved in one another before being added to the dispersion ii) according to step iii), and/or wherein the temperature of the two or more different type I photoinitiators during dissolution in one another is preferably 40° C., and/or wherein the dissolution in one another takes place preferably overnight, more preferably for 16 hours.

9. A method for using the composition according to claim 1 as a coating compound, preferably as a troweling compound, the UV-light-curable composition preferably being used for the coating of surfaces; and/or the UV-light-curable composition more preferably being applied to a surface by troweling; and/or wherein the surfaces are selected preferably from the group comprising surfaces of plastics, surfaces of glass-fibre-reinforced plastics, surfaces of carbon-fibre-reinforced plastics, surfaces of rotor blades of wind turbines, surfaces of metals, and surfaces of wood; more preferably from surfaces of plastics, surfaces of glass-fibre-reinforced plastics, surfaces of carbon-fibre-reinforced plastics, surfaces of rotor blades of wind turbines, and surfaces of metals; particularly preferably from surfaces of glass-fibre-reinforced plastics, surfaces of carbon-fibre-reinforced plastics, and surfaces of rotor blades of wind turbines.

10. A process for coating a surface, the process comprising the steps of:
I) providing a composition according to claim 1;
II) applying the composition to a surface, preferably using a trowel, until a coloured layer of the composition has formed on the surface;
III) treating the coloured layer with UV light, preferably with a handheld UV lamp, more preferably with a handheld LED UV lamp, to cure the composition until the layer undergoes a change in colour to completely colourless, thereby indicating the formation of a cured layer, preferably a completely cured layer;
IV) optionally further working of the cured layer, preferably by sanding;
V) optionally repeating steps II) to IV) until at least one further cured layer has formed;
VI) optionally further working and applying of further layers, the further layers being different from the cured layers from the preceding steps, and/or the further layers being selected preferably from paints, water-based paints, emulsion paint, topcoat and leading edge protection.

11. A coated product, wherein the coated product includes a surface, and cured layer of the composition according to claim 1 applied thereon, and/or wherein the cured layer has a layer thickness of up to 5 mm; and/or wherein the surface is selected preferably from the group comprising surfaces of plastics, surfaces of glass-fibre-reinforced plastics, surfaces of carbon-fibre-reinforced plastics, surfaces of rotor blades of wind turbines, surfaces of metals, and surfaces of wood; and/or wherein the coated product has been produced preferably according to a process comprising the steps of:
I) providing a composition according to claim 1;
II) applying the composition to a surface, preferably using a trowel, until a coloured layer of the composition has formed on the surface;
III) treating the coloured layer with UV light, preferably with a handheld UV lamp, more preferably with a handheld LED UV lamp, to cure the composition until the layer undergoes a change in colour to completely colourless, thereby indicating the formation of a cured layer, preferably a completely cured layer;
IV) optionally further working of the cured layer, preferably by sanding;
V) optionally repeating steps II) to IV) until at least one further cured layer has formed;
VI) optionally further working and applying of further layers, the further layers being different from the cured layers from the preceding steps, and/or the further layers being selected preferably from paints, water-based paints, emulsion paint, topcoat and leading edge protection.
